(19) United States
(12) Patent Application Publication
(10) Pub. No.: US 2006/0138962 A1
(43) Pub. Date: Jun. 29, 2006

(54) Ceramic Discharge Vessel with Expanded Reaction-Bonded Aluminum Oxide Member

(76) Inventors: George C. Wei, Weston, MA (US); Roland Huettinger, Kaufering (DE); Walter P. Lapatovich, Boxford, MA (US); Klaus Guenther, Berlin (DE)

Correspondence Address: OSRAM SYLVANIA INC, 100 ENDICOTT STREET, DANVERS, MA, 01923, US

(21) Appl. No.: 10/905,326

(22) Filed: Dec. 28, 2004

(51) Int. Cl. H01J 17/18; H01J 17/20

(52) U.S. Cl. 313/634; 313/573; 313/493; 445/26

(57) ABSTRACT

A ceramic discharge vessel is provided wherein the discharge vessel has a ceramic body and at least one expanded reaction-bonded aluminum oxide member hermetically sealed to the ceramic body. The method of making the discharge vessel includes (a) forming a ceramic body; (b) forming a reaction-bonded aluminum oxide member in a green state by compacting a mixture of aluminum metal and aluminum oxide powders; (c) assembling the ceramic body and the reaction-bonded aluminum oxide member in the green state to form an assembly; and (d) reaction sintering the assembly to cause the reaction-bonded aluminum oxide member to expand and form a hermetic seal with the ceramic body.

### TECHNICAL FIELD

This invention relates to ceramic discharge vessels and in particular to discharge vessels for high-intensity discharge applications that include a sapphire tube body.

### BACKGROUND OF THE INVENTION

Ceramic discharge vessels are generally used for high-intensity discharge (HID) lamps such as high-pressure sodium (HPS), high-pressure mercury, and metal halide lamps. Typically, these discharge vessels are formed from multiple ceramic components that are co-sintered to form hermetic seals between the parts without the use of a frit material. This technique relies on a differential shrinkage of the ceramic components to create an interference fit between the parts. The preferred ceramic for HID lamp applications is polycrystalline alumina (PCA), although other ceramics such as sapphire, yttrium aluminum garnet, aluminum nitride and aluminum oxynitride may also be used.

Sapphire is an excellent transparent ceramic material, except that it is limited to straight shapes defined by crystal growth techniques. Single-crystal sapphire tubes typically grown by the EFG (edge-defined, film-feed growth) method are useful for ceramic metal halide lamps. However, while PCA to PCA seals rely on the differential shrinkage of the PCA parts, this technique is normally not applicable to sapphire to PCA seals because the sapphire tube does not shrink during the sintering of PCA parts. As a solution, some recent designs of ceramic discharge vessels for low wattage, automotive applications use polycrystalline alumina hats that fit over the ends of the sapphire tube. See, e.g., International Patent Application No. WO 99/41761. The PCA hat shrinks around the end of sapphire tube during sintering to create a seal with the exterior surface of the tube. However, the high thermal mass of the PCA hat causes high heat losses via radiation from the hat's surface and induces a severe thermal stress that can lead to a high incidence of cracking. In addition, the cost of this sapphire-PCA construction is relatively high compared to competing technologies. Unfortunately, sapphire tubes with frit-sealed PCA plugs are not a suitable alternative since the frit, in this type of construction, is too close to the higher temperature region and is consequently attacked more rapidly by the corrosive metal halide fill leading to early failure of the lamp.

### SUMMARY OF THE INVENTION

Reaction-bonded aluminum oxide (RBAO) is a relatively new class of ceramic material with low (<1%) dimensional shrinkage. RBAO is new relative to conventional sintering of alumina in that both reactions and sintering take place in the compacted body simultaneously during heating. The method of producing strong RBAO bodies starts with compacts of milled mixtures of aluminum metal and aluminum oxide powders that are heat treated at about 1200 to about 1550° C. Typically, it is desired that the expansion due to the Al metal to Al₂O₃ reaction and the shrinkage on sintering of the Al₂O₃ be nearly balanced.

However, unlike prior applications for RBAO, the present invention involves coaxing the RBAO into a range where densification is accompanied by a small expansion during heating. The expansion of the RBAO component is used to create the hermetic seal between ceramic components. In effect, the RBAO part swells and seals against a constricting surface. This is can be thought of as the opposite of the differential shrinkage method used for PCA.

Since the RBAO expands during sintering, it is possible to use an inserted RBAO plug in a sapphire tube to seal the ends of the tube and thereby eliminate the use of an external PCA hat. This construction should result in a better thermal profile, less stresses, and higher survivability. While an internally-sealed plug construction is preferred, the use of expanded RBAO is not limited to forming internal seals within the arc tube. For example, it is also possible to use the expanded RBAO in the hat configuration whereby the expansion of the RBAO during sintering causes a constriction of the hat around the outer surface of the tube to form an external seal. Thus, the use of expanded RBAO for creating hermetic seals allows more flexibility in the manufacturing of ceramic discharge vessels.

Therefore, in accordance with an aspect of the invention, there is provided a ceramic discharge vessel comprising a ceramic body and at least one expanded reaction-bonded aluminum oxide member hermetically sealed to the ceramic body.

In accordance with another aspect of the invention, there is provided a method of forming a hermetic seal in a ceramic discharge vessel, the method comprising: (a) forming a ceramic body; (b) forming a reaction-bonded aluminum oxide member in a green state by compacting a mixture of aluminum metal and aluminum oxide powders; (c) assembling the ceramic body and the reaction-bonded aluminum oxide member in the green state to form an assembly; and (d) reaction sintering the assembly to cause the reaction-bonded aluminum oxide member to expand and form a hermetic seal with the ceramic body.

### BRIEF DESCRIPTION OF THE DRAWINGS

FIG. 1 is a cross-sectional illustration of a ceramic discharge vessel for an electrodeless lamp in accordance with this invention.

FIG. 2 is an illustration of an annular sealing member in accordance with this invention.

FIG. 3 is a cross-sectional illustration of a 5-piece ceramic discharge vessel according to this invention that incorporates the annular sealing member of FIG. 2.

FIG. 4 is a cross-sectional illustration of a 3-piece ceramic discharge vessel according to this invention wherein the sealing member has an integral capillary tube.

FIG. 5 is a cross-sectional illustration of an alternate embodiment of the ceramic discharge vessel shown in FIG. 1.

FIG. 6 is a cross-sectional illustration of a ceramic discharge vessel for an HPS lighting application in accordance with this invention.

FIG. 7 is a cross-sectional illustration of an alternate embodiment of the ceramic discharge vessel shown in FIG. 6.

FIG. 8 is a cross-sectional illustration of a ceramic discharge vessel according to this invention that has expanded RBAO capillary tubes.

### DETAILED DESCRIPTION OF THE INVENTION

For a better understanding of the present invention, together with other and further objects, advantages and capabilities thereof, reference is made to the following disclosure and appended claims taken in conjunction with the above-described drawings.

The general equation for the total dimensional change, S, after a complete reaction-bonding cycle for an RBAO ceramic is given by Equation (1) below:
S=[(1+ΣνᵢVᵢ)(ρₒ/ρ)/(1+0.28fV_{Al})]^{1/3}−1 (1)
where νᵢ is the volume expansion associated with the respective oxidation (e.g., ν_{Al}=0.28, ν_{Zr}=0.49, ν_{Ti}=0.76, ν_{Cr}=1.02), Vᵢ is the volume fraction of metal (including V_{Al}) or ceramic phases added in the original powder mixture, f is the Al fraction oxidized during milling, and ρₒ and ρ are the green and final densities, respectively. Equation (1) indicates that a higher volume fraction of Al and a high green density can yield a final expansion (rather than shrinkage) during sintering of the Al/Al₂O₃ compacts. Typically a volume expansion of about 1-4% occurs at ˜700° C. because of the melting of the Al phase. When this expansion occurs, it is theorized that the molten Al metal will spread from the Al/Al₂O₃ part to fill the gap between the parts so as to form a hermetic seal upon further reaction sintering.

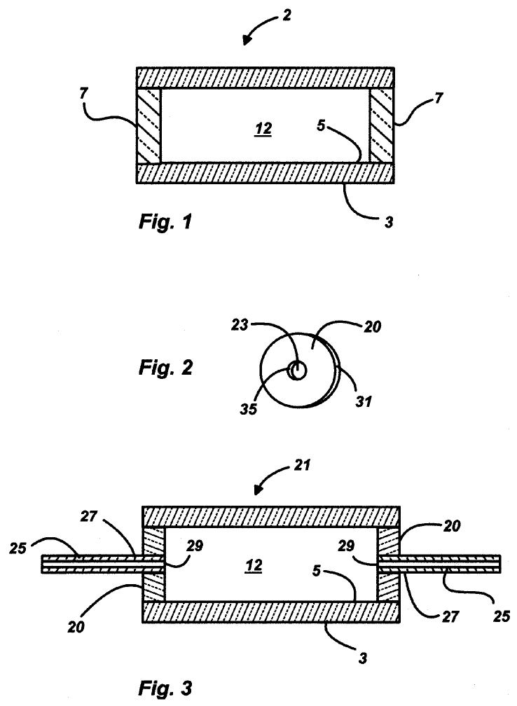

FIG. 1 is a cross-sectional illustration of a ceramic discharge vessel for an electrodeless lamp in accordance with this invention. The discharge vessel 2 has a tubular body 3 and sealing members 7 which together define a discharge chamber 12. The tubular body 3 is comprised of a ceramic material, preferably translucent PCA or sapphire. Sealing members 7 are comprised of expanded RBAO plugs. An alternate embodiment of this discharge vessel is shown in FIG. 5. Here, recesses 43 have been made in the ends of tubular body 3′ of discharge vessel 2′ in order to receive sealing members 7. The edges 45 of the recess 43 limit the insertion depth of the sealing members 7 thereby providing for more accurate positioning.

In a preferred method of manufacture, the sealing members 7 in their green state would be inserted into the ends of a PCA or sapphire tube and expanded by reaction sintering. As the diameter of the RBAO plugs expands during reaction sintering, an interference fit is created with the constricting inner surface 5 of the tubular body 3 and a hermetic seal is formed between the tubular body 3 and the sealing members 7. In the case of PCA, the PCA tube may be fully sintered to prior to combining it with the RBAO plug in which case only minimal shrinkage of the PCA tube may occur during the reaction sintering of the RBAO parts, or the PCA tube may be only prefired in which case the PCA tube will shrink as the RBAO parts are expanded during the reaction sintering step. In the latter case, the alumina tube is prefired at 850° C. to 1350° C. before being combined with the green RBAO part. The assembled parts are then reaction sintered at a temperature less than 1350° C. to at least partially bond the parts and then sintered at a higher temperature to about 1850° C. in hydrogen, an N₂-H₂ mixture, or vacuum, to increase transmittance and finish the seal. A sinter-HIP (hot isostatic pressing) process which sinters the assembly to a closed-pore stage followed by HIP may also be used to bring about high transmittance.

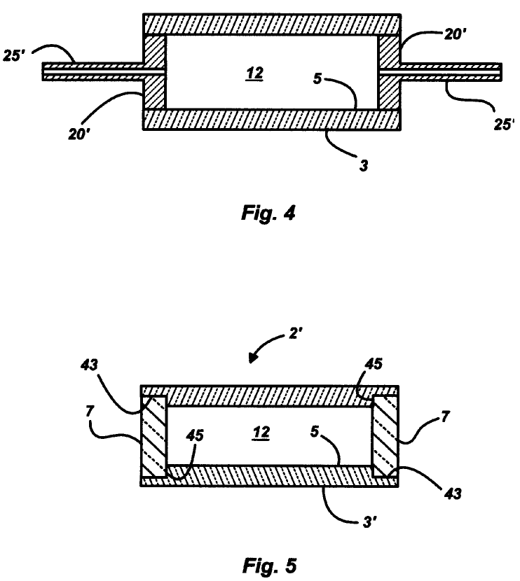

FIG. 3 is a cross-sectional illustration of a 5-piece ceramic discharge vessel. In this embodiment, the discharge vessel 21 has tubular body 3 and is sealed with annular sealing members 20 (shown separately in FIG. 2). The annular sealing members 20 have an aperture 23 for receiving capillary tube 25. Capillary tube 25 has a bore 29 suitable for receiving an electrode assembly (not shown). Preferably, capillary tube 25 is comprised of PCA that has been at least prefired, and, more preferably, fully sintered, before being inserted into the green RBAO sealing member. As the RBAO sealing member expands during sintering, hermetic seals are formed as a result of interferences fits between cylindrical outer surface 31 of annular sealing member 20 and inner surface 5 of tubular body 3 as well as between cylindrical surface 35 of aperture 23 and outer surface 27 of capillary tube 25. In an alternate embodiment shown in FIG. 4, the annular sealing members 20′ and the capillary tubes 25′ are made as an integral piece composed of expanded RBAO.

With respect to the discharge vessels shown in FIGS. 3 and 4, a metal halide fill material may be inserted into the discharge chamber 12 after the hermetic seals have been formed between the ceramic parts. A typical metal halide fill material comprises mercury plus a mixture of metal halide salts, e.g., Nal, Cal₂, Dyl₃, Hol₃, Tml₃, and TIl. The discharge chamber 12 will also contain a buffer gas, e.g., 30 to 300 torr Xe or Ar. Higher fill gas pressures may also be used, e.g., 1-30 bar Xe at 20° C. Such higher pressures are useful for lamps where instant starting is required, e.g., automotive lamps. Electrode assemblies are inserted into each capillary tube 25 such that one end protrudes out of the discharge vessel to provide an electrical connection. The tips of the electrode assemblies that extend into the discharge chamber are fitted with a tungsten coil or other similar means for providing a point of attachment for the arc discharge. The electrode assemblies are sealed hermetically to the capillary tubes by a frit material (preferably, a Al₂O₃—SiO₂—Dy₂O₃ frit).

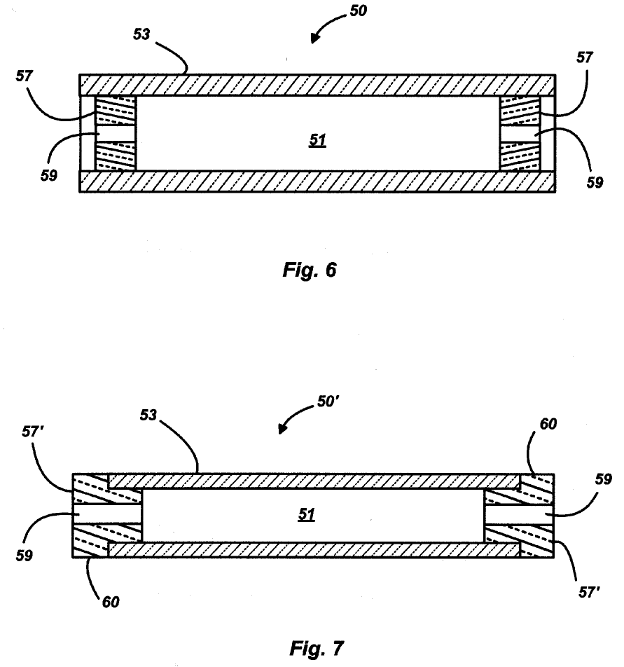

FIGS. 6 and 7 are cross-sectional illustrations of two alternate embodiments of ceramic discharge vessels for HPS lamps in accordance with this invention. The discharge vessel 50 has a tubular body 53 comprised of PCA. Annular plugs 57 comprised of expanded RBAO are sealed in each end of the tubular body 53 thereby defining discharge chamber 51. The aperture 59 in annular plugs 57 is for receiving an electrode assembly which typically consists of a niobium feedthrough to which a tungsten electrode is attached. The niobium feedthrough is frit sealed in the aperture after a sodium/mercury amalgam and a buffer gas has been added to discharge chamber 51. In FIG. 7, the annular plugs 57′ of discharge vessel 50′ have a flange 60 that seats against the end of the tube to provide for more accurate positioning of the annular plug 57′.

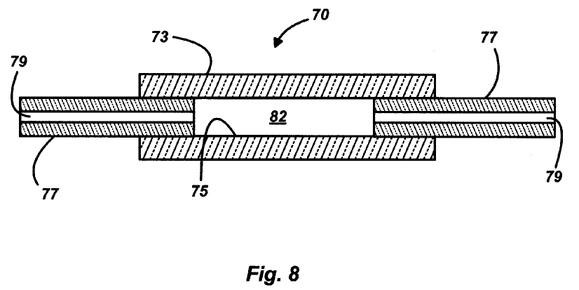

FIG. 8 is a further embodiment of this invention wherein the ceramic discharge vessel 70 has a tubular body 73 and capillary tubes 77. The tubular body 73 may be comprised of sapphire or PCA and the capillary tubes 77 are comprised of expanded RBAO. The capillary tubes 77 are inserted to a predetermined depth thereby defining discharge chamber 82 and are expanded during the reaction sintering of the RBAO to form a hermetic seal with the inner surface 75 of the tubular body 73. The capillary tubes 77 have a bore 79 for receiving an electrode assembly and discharge chamber 82 may be filled with the metal halide fill described previously.

In order to demonstrate the capability of expanded RBAO to form hermetic seals, solid RBAO plugs were made and sealed into the ends of sintered PCA tubes. In particular, aluminum metal powder having an average 20 μm particle size (Johnson-Matthey) was admixed with alumina powder (CR6 or CR1 from Baikowski) in amounts of 30, 40, 50, and 60 volume percent (vol %). CR6 alumina powder which has a surface area of 6 m²/g was preferred because of its sinterability. Finer aluminum powders are available, but submicron aluminum powders would require special precautions as spontaneous combustion could occur. For aluminum powders greater than 1 μm, handling in air at ambient temperature is acceptable. Aluminum metal volume content may be in a range from 10 to 70 volume percent, and preferably from 50 to 60 vol %. When the aluminum metal content is high (>60 vol %), the pressed parts tend to be soft and frail making handling more difficult. The Al/Al₂O₃ mixtures were ball-milled for 2 hours in methanol using 5 mm ZrO₂ balls and high-density polyethylene bottles. Methanol was used for ball milling since aluminum metal powder reacts with water. Ball milling was limited to 2 hours to prevent excessive pick up of ZrO₂ from the media. After pan drying, the powder was broken up using mortar/pestle. The powders were uniaxially pressed or isopressed at 35 ksi or higher. Because aluminum metal deforms under pressure, the Al/Al₂O₃ compacts could achieve a high green density of 60-80% of theoretical density. If needed, the green plugs could be machined to a predetermined size. The green RBAO plugs were 4.90 mm in diameter by 2 mm thick, and the PCA outer tubes had a 4.95 mm ID. After assembly with the outer tube, the entire samples were reaction-sintered under flowing air or oxygen using the following temperature cycle: (1) heating at 1° C./min to 700° C. with a hold at 700° C. for 24 h; (2) continue heating at 1° C./min to 1100° C. with a hold at 1100° C. for 24 h; (3) continue heating at 1° C./min to 1550° C. with a hold at 1550° C. for 24 h; and finally cooling at 30° C./min to room temperature. The final hold temperature could be higher than 1550° C., e.g., 1600-1900° C., in order to promote full densification. This depends on the starting green density and particles sizes of the Al and Al₂O₃ phases. A pure oxygen atmosphere is preferred, because it results in a faster oxidation of the Al metal particles to Al₂O₃. A slow ramping of the temperature limited cracking of the tube. Higher ramp rates such as 2° C./min to 5° C./min resulted in cracking of the outer tubes, probably because of a lack of stress relaxation. A temperature of 1550° C. was sufficient to form hermetic body and direct bonds of the expanded RBAO plugs to the outer alumina tubes.

During reaction sintering, the RBAO plugs had a final expansion of 0.35 mm as the diameter increased from 4.90 mm to 5.25 mm resulting in a net interference of about 6%. Longitudinal cracks in the outer PCA tubes appeared after the reaction sintering cycle when high temperature ramp rates (5° C./min) were used. The length of the bond between the expanded RBAO plug and outer alumina tube was 2 mm. Successfully bonded tubes were leak tight to <10⁻⁹ scc/sec.

While there has been shown and described what are at the present considered the preferred embodiments of the invention, it will be obvious to those skilled in the art that various changes and modifications may be made therein without departing from the scope of the invention as defined by the appended claims.

What is claimed is:

1. A ceramic discharge vessel comprising a ceramic body and at least one expanded reaction-bonded aluminum oxide member hermetically sealed to the ceramic body.

2. The ceramic discharge vessel of claim 1 wherein the ceramic body is a tube and the expanded reaction-bonded aluminum oxide member is sealed to the inner surface of the tube.

3. The ceramic discharge vessel of claim 2 wherein the ceramic body is comprised of polycrystalline alumina or sapphire.

4. The ceramic discharge vessel of claim 2 wherein the ceramic body is comprised of sapphire.

5. The ceramic discharge vessel of claim 2 wherein the expanded reaction-bonded aluminum oxide member has an aperture and a capillary tube is inserted in the aperture.

6. The ceramic discharge vessel of claim 5 wherein the expanded reaction-bonded aluminum oxide member and the capillary tube are formed as a single piece.

7. The ceramic discharge vessel of claim 5 wherein the capillary tube is composed of polycrystalline alumina.

8. The ceramic discharge vessel of claim 1 wherein the ceramic body is a tube and the expanded reaction-bonded aluminum oxide member is positioned in a recess in an end of the tube.

9. The ceramic discharge vessel of claim 2 wherein the expanded reaction-bonded aluminum oxide member has an aperture.

10. The ceramic discharge vessel of claim 9 wherein the expanded reaction-bonded aluminum oxide member has a flange that seats against an end of the tube.

11. The ceramic discharge vessel of claim 2 wherein the ceramic body is a tube and the expanded reaction-bonded aluminum oxide member is a capillary tube.

12. The ceramic discharge vessel of claim 11 wherein the ceramic body is comprised of sapphire.

13. The ceramic discharge vessel of claim 1 wherein the ceramic body is a tube and the expanded reaction-bonded aluminum oxide member is sealed to the exterior surface of the tube.

14. A method of forming a hermetic seal in a ceramic discharge vessel comprising:
(a) forming a ceramic body;
(b) forming a reaction-bonded aluminum oxide member in a green state by compacting a mixture of aluminum metal and aluminum oxide powders;
(c) assembling the ceramic body and the reaction-bonded aluminum oxide member in the green state to form an assembly; and
(d) reaction sintering the assembly to cause the reaction-bonded aluminum oxide member to expand and form a hermetic seal with the ceramic body.

15. The method of claim 14 wherein the aluminum metal powder comprises from 10 to 70 volume percent of the mixture.

16. The method of claim 14 wherein the aluminum metal powder comprises from 50 to 60 volume percent of the mixture.

17. The method of claim 14 wherein the reaction-bonded aluminum oxide member in the green state has a green density of 60 to 80 percent.

18. The method of claim 14 wherein the ceramic body is comprised of polycrystalline alumina that has been at least prefired prior to forming the assembly.

19. The method of claim 14 wherein the ceramic body has been fully sintered prior to forming the assembly.

20. The method of claim 14 wherein the ceramic body shrinks during reaction sintering of the assembly.
